(19) United States
(12) Patent Application Publication
(10) Pub. No.: US 2010/0275453 A1
(43) Pub. Date: Nov. 4, 2010

(54) WIRE SAW WITH SAWTEETH STRIP UPDATING STRUCTURE

(76) Inventor: Chung-Hung Huang, Taipei City (TW)

Correspondence Address: Chung-Hung Huang, 235 Chung - Ho Box 8-24 Taipei, Taiwan, R. O. C., Taipei, 235, TW

(21) Appl. No.: 12/435,396

(22) Filed: May 4, 2009

(51) Int. Cl. B27B 21/06; B26D 1/547

(52) U.S. Cl. 30/513; 83/651.1

(57) ABSTRACT

A wire saw with sawteeth strip updating structure is provided. A buckling structure is designed in the wire saw. The buckling structure is hidden the handle portion of the saw and includes a connecting unit and a combining unit. The connecting unit can be buckled or unbuckled from the combining unit. The sawteeth strip is connected to the combining unit in a tense state. In updating, the user only needs to push a guide sheet to release the connecting unit from the combining unit. Then the sawteeth strip is taken out easily from the saw for updating a new one. The operation is unnecessary to clamp the saw by a great force for the updating operation.

### FIELD OF THE INVENTION

The present invention relates to saws, in particular to a wire saw with sawteeth strip updating structure.

### BACKGROUND OF THE INVENTION

There are many wired saws being disclosed in the Prior art, such as U.S. Pat. No. 7,308,844, in that a tile saw is disclosed. The saw includes a base, a frame assembly disposed on the base, a first rail disposed on the frame assembly, the first rail having a longitudinal axis, a table slidingly disposed on the first rail, a support assembly disposed on the base, a saw assembly supported by the support assembly, the saw assembly including a motor, a cutting wheel driven by the motor, the saw assembly being pivotable about a horizontal axis substantially parallel to the longitudinal axis, and a switch electrically connected to the motor and disposed on the support assembly so that, when the motor assembly is pivoted about the horizontal axis, the switch remains stationary.

However a common shortcoming for the wired saws is that it is very difficult to update the saw. In update of the saw, the user must take a great force to clamp the body of the saw so as to release the sawteeth stripe from the body of the saw, while this operation must be made by the body and hands of the saw and the operation is also dangerous since it is possible that the saw will eject from the body of the saw so as to hurt someone beside the saw.

### SUMMARY OF THE INVENTION

Accordingly, the object of the present invention is to provide a wire saw with sawteeth strip updating structure. A buckling structure is designed in the present invention. The buckling structure is hidden the handle portion of the saw. In updating, the user only needs to push a guide sheet to release the buckling structure. Then the sawteeth strip is taken out easily from the saw for updating a new one. The operation is unnecessary to clamp the saw by a great force for the updating operation.

The various objects and advantages of the present invention will be more readily understood from the following detailed description when read in conjunction with the appended drawing.

### BRIEF DESCRIPTION OF THE DRAWINGS

FIG. 1 shows an outer experience of the wire saw of the present invention.

FIG. 2 is an exploded perspective view of the present invention.

FIG. 3 is a front view of the wire saw of the present invention.

FIG. 4 is a partial enlarged view showing a buckling set of the present invention, where the buckle set is at a buckling state.

FIG. 5 is a partial enlarged view showing a buckling set of the present invention, where the buckle set is at an unbuckling state.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

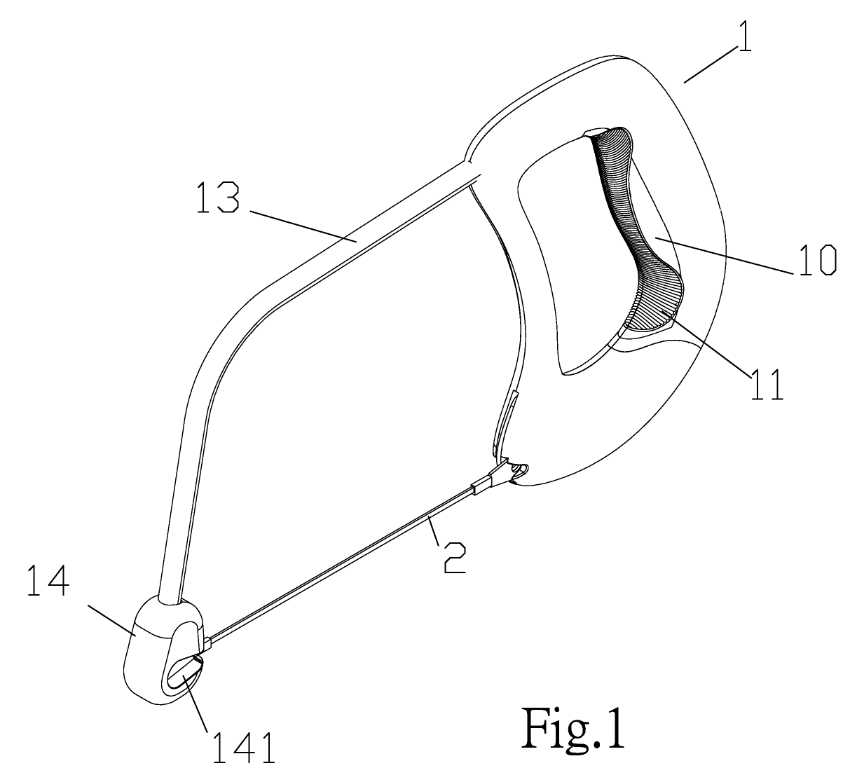

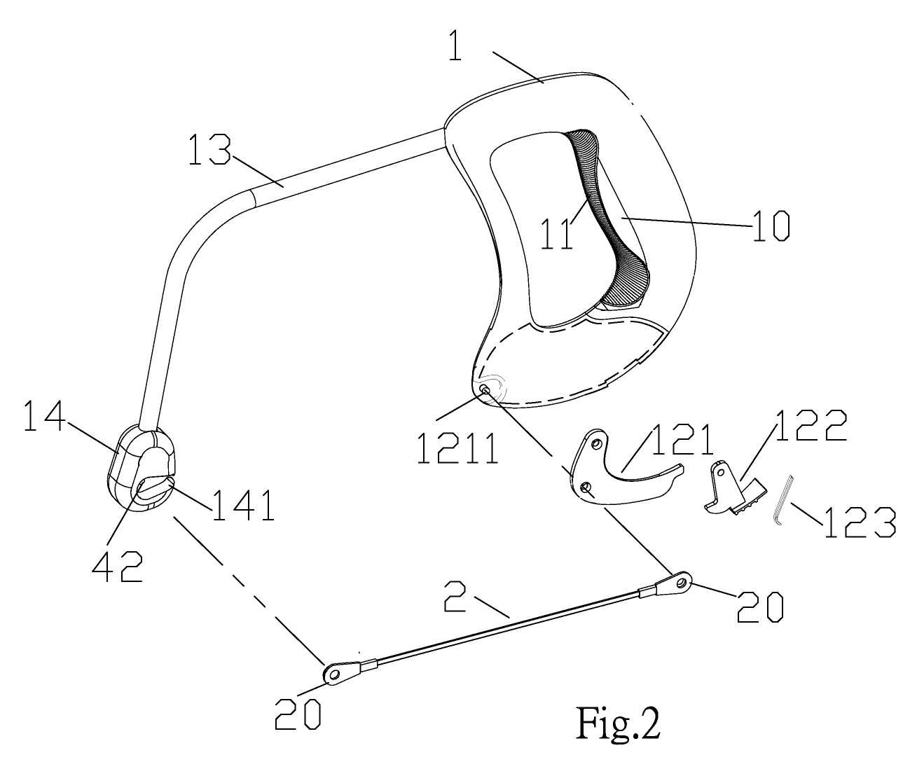

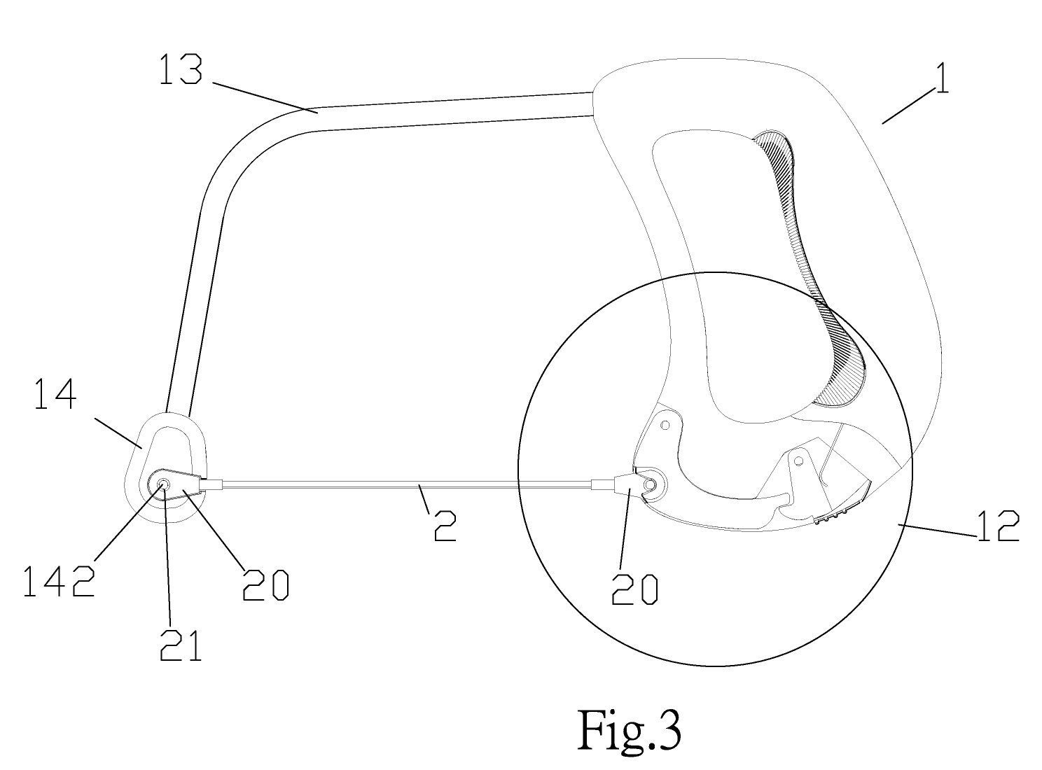

Referring to FIGS. 1 to 3, it is illustrated that the wire saw of the present invention has the following elements.

A body 1 has an approximate U shape. One end of the body 1 is formed with a handle portion 10. A lower portion of the handle portion 10 is formed with a hollow portion. The handle portion 10 has an arc shape. A surface of the handle portion 10 is formed with a friction portion 11 for holding it firmly.

A buckle set 12 is formed in the hollow portion of the handle portion 10.

A sawteeth strip 2 is fixed between two ends of the U shape body 1. Each of two ends of the sawteeth strip 2 is formed with a retaining sheet 20. Each retaining sheet 20 is formed with a retaining hole 21.

The buckle set 12 includes the following elements.

A connecting unit 121 has a concave portion at one side thereof for buckling with other elements. Another side opposite to the side having the concave portion is formed with a recessed portion 1210. A positioning post 1211 is extended from the recessed portion 1210. A retaining hole 21 of the sawteeth strip 2 is engaged with the positioning post 1211 so as to fix the sawteeth strip 2.

A combining unit 122 is formed with a convex portion having a shape corresponding to the concave portion of the connecting unit 121. The convex portion of the combining unit 122 can buckle the concave portion of connecting unit 121 so that the connecting unit 121 is buckled to the combining unit 122.

An elastic unit 124 has one end connected to an inner wall of the body 1 and another end resisting against the combining unit 122. The elastic unit 124 provides an elastic force to eject the combining unit 122.

A guide sheet 124 is connected to a lower side of the combining unit 122. To push the guide sheet 124, the combining unit 122 will move therewith. The hollow portion of the handle portion 10 of the body 1 is formed with an opening. The lower side of the guide sheet 124 protrudes out of the opening so that the operator can move the guide sheet 124 from the lower side of the guide sheet 124 to remove the combining unit 122.

The body 1 is formed with a retaining arc 13 which extends from an upper end of the body 1. A lower end of the retaining arc 13 is formed with a retaining block 14.

The retaining block 14 is formed with a recessed portion 141. A positioning post 142 extends from the recess portion 141. The hole in another end of the sawteeth strip 2 is engaged with the positioning post 142 of the retaining block 14 for retaining the sawteeth strip 2.

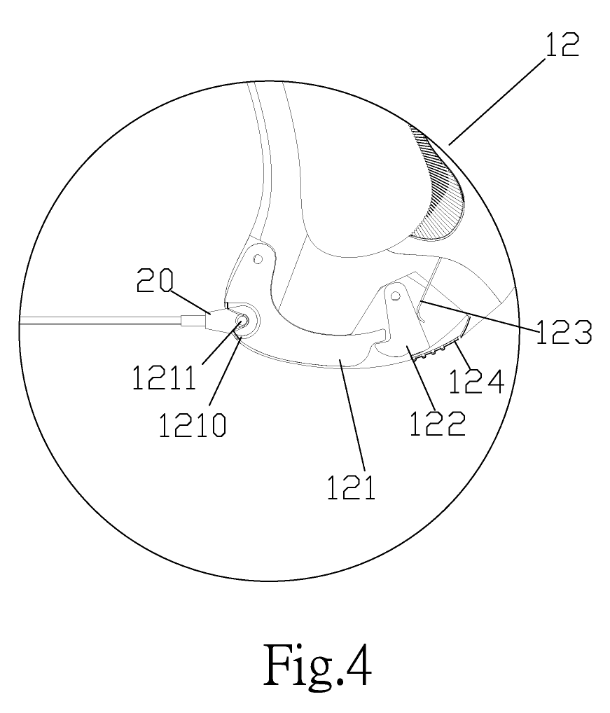

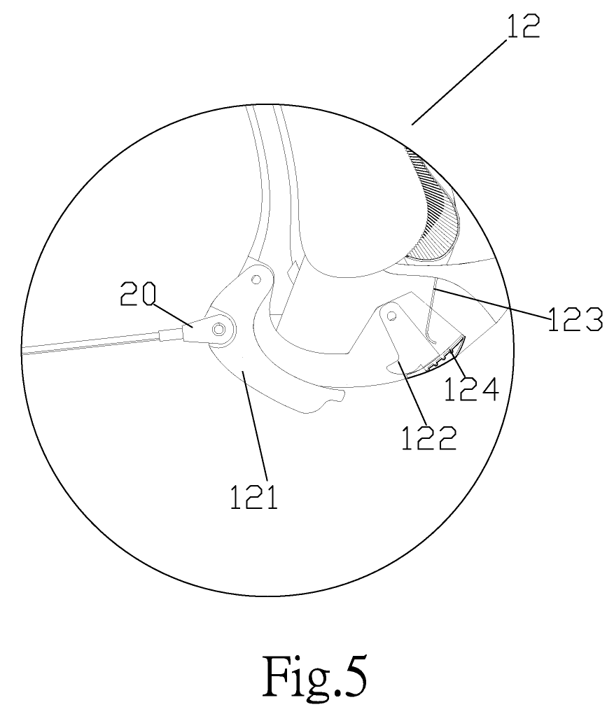

Referring to FIGS. 4 and 5, it is illustrated that in the present invention, when an operator desires to update the sawteeth strip 2, it is only necessary to push the guide sheet 124 rightwards, the connecting unit 121 and the connecting unit 121 will separate from one another. The user can take out the sawteeth strip 2 easily for updating a new one. In installation, the retaining holes 21 of the sawteeth strip 2 are engaged to the positioning post 1211 of the body 1 and the positioning post 142 of the retaining arc 13, respectively. Then the connecting unit 121 is pushed upwards and the combining unit 122 will buckle the connecting unit 121 by the elastic force of the elastic unit 124 so as to fix the sawteeth strip 2 to the body 1.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A wire saw with sawteeth strip updating structure, comprising:
a body having an approximate U shape; one end of the body being formed with a handle portion; a lower portion of the handle portion being formed with a hollow portion; the handle portion having an arc shape;
a buckle set being formed in the hollow portion of the handle portion;
a sawteeth strip fixed between two ends of the U shape body; one end of the sawteeth strip being formed with a first retaining portion and another end of the sawteeth strip being formed with a second retaining portion;
the buckle set including:
a connecting unit having a first buckle unit; another side opposite to the side having the first buckling unit being extended with a first positioning portion; the first retaining portion of the sawteeth strip being engaged with the first positioning portion so as to fix the sawteeth strip;
a combining unit formed with a second buckling unit which is shaped corresponding to that of the first buckling unit so that the combining unit can buckle the connecting unit;
an elastic unit having one end connected to an inner wall of the body and another end resisting against the combining unit; the elastic unit providing an elastic force to eject the combining unit;
a guide sheet connected to a lower side of the combining unit; to push the guide sheet, the combining unit will move therewith; the hollow portion of the handle portion of the body being formed with an opening at a lower side of the hollow portion; a lower side of the guide sheet protruding out of the opening so that the operator can move the guide sheet from the lower side of the guide sheet to remove the combining unit; and
the body being formed with a retaining arc which extends from an upper end of the body; a lower end of the retaining arc being formed with a retaining block; the retaining block being formed with a second positioning portion; the second retaining portion of the sawteeth strip is retained to the second positioning portion; and
wherein when it is desired to release the sawteeth strip from the body, the guide sheet is moved from the lower side of the guide sheet to remove the combining unit so that the first buckling unit is unbuckled from the second buckling unit; and thus the combining unit is released from the connecting unit; the connecting unit moves outwards so that the sawteeth strip can be taken down easily for updating a new one; then the connecting unit is pushed toward the combining unit so that the first bucking unit is bucked to the second bucking unit to fix the sawteeth strip firmly to the body.

2. The wire saw with sawteeth strip updating structure as claimed in claim 1, wherein the first buckling unit in the connecting unit is a concave portion and the second buckling unit in the combining unit is a convex portion.

3. The wire saw with sawteeth strip updating structure as claimed in claim 1, wherein the first buckling unit in the connecting unit is a convex portion and the second buckling unit in the combining unit is a concave portion.

4. The wire saw with sawteeth strip updating structure as claimed in claim 1, wherein the saw is used for cutting tiles.

5. The wire saw with sawteeth strip updating structure as claimed in claim 1, wherein a surface of the handle portion is formed with a friction portion for holding it firmly.

6. The wire saw with sawteeth strip updating structure as claimed in claim 1, wherein each of the first positioning portion and the second positioning portion is a post and each of the first retaining portion and the second retaining portion is a hole.
